(19) United States
(12) Patent Application Publication
(10) Pub. No.: US 2002/0095498 A1
(43) Pub. Date: Jul. 18, 2002

(54) Network architecture for multi-client units

(75) Inventors: Gautam Chanda, Fremont, CA (US); Subrata Banerjee, San Ramon, CA (US); Rajan Aiyer, Fremont, CA (US); Viswa Sharma, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Accordion Networks, Newark, CA (US)

(21) Appl. No.: 09/872,755

(22) Filed: Jun. 1, 2001

Related U.S. Application Data
(60) Provisional application No. 60/209,514, filed on Jun. 5, 2000.

(51) Int. Cl. G06F 15/173

(52) U.S. Cl. 709/225; 709/238

(57) ABSTRACT

A network system includes a plurality of integrated access devices (IADs) assigned to a plurality of clients in a multi-client unit (MCU). At least one IAD is assigned to each of the plurality of clients in the multi-client unit to transmit and receives units of information. The IADs is configured to prioritize data transmission according to the type of information included in the units of information. An MCU gateway device is assigned to the multi-client unit and coupled to the plurality of IADs to receive or transmit the units of information. The gateway device is configured to prioritize the units of information according to the type of information included in the units of information. A regional switching device is assigned to a geographic region including the MCU. The regional switching device is coupled to the gateway device to transmit or receive the units of information to and from the gateway device, wherein the unit of information is any block of data suitable for transmission from a first node to a second node in the network system.

### CROSS-REFERENCES TO RELATED APPLICATION

This application claims priority from U.S. Provisional Patent Application No. 60/209,514, entitled “NETWORK ARCHITECTURE FOR MULTI-CLIENT UNITS,” filed Jun. 5, 2000, which is herein incorporated by reference for all purposes.

### BACKGROUND OF THE INVENTION

The present invention relates to information handling systems, and more particularly to multi service access platforms for providing bundled services to a group of users in a multi-client unit, multi-tenant unit, multi-business building, business park, school campus, and the like.

As networks provide greater connectivity and access to information, there is an increasing demand for data communication at higher rates to accommodate multimedia information. One solution is to provide increased data rates by replacing existing twisted-pair copper wiring with high bandwidth media, such as coaxial cable or fiber optic links. However, it is extremely costly to connect every users with high bandwidth media. Another solution is to adopt improved transmission techniques using the existing hardware infrastructure. For example, digital subscriber line (“xDSL”) technology provides higher bandwidth data service over existing twisted pair wiring. The xDSL technology allow data, voice, and video to be transmitted simultaneously over standard twisted-pair copper wiring at multi-megabit rates.

There are a number of competing xDSL technologies such as asymmetric digital subscriber line (“ADSL”), rate adoptive digital subscriber line (“RADSL”), high bit-rate digital subscriber line (“HDSL”), and very-high-bit-rate digital subscriber line (“VDSL”). Each is suited to a different application with trade-off made between signal distance and speed. Arguably, two most promising xDSL technologies are ADSL and VDSL. ADSL provides more transmission bandwidth “downstream” to a telephone subscriber than “upstream” from the telephone subscriber. At present time, downstream transmission rates range between 1.5 Mbps to a theoretical 8 Mbps, and upstream transmission rates range between 16 kbps to a theoretical 1 Mbps or more. VDSL is the fastest xDSL technology. At present time, it can deliver downstream transmissions at a rate of 13 to 52 Mbps and upstream transmissions at a rate of 1.5 to 26 Mbps.

Both VDSL and ADSL technologies generally use a mechanism called Discrete Multi-Tone Technology (“DMT”) in which the bandwidth above normal telephony audio (0-4 KHz) is utilized to deliver high speed data, e.g., video service. This technology is defined in ANSI Document T1.413 and consists of splitting the bandwidth above 4 KHz into an upstream data spectrum and a downstream data spectrum. Data is transmitted as multiple tones with a 4.3 KHz spacing between successive tones. The resulting signals at both ends of the twisted wire pair (copper) are subjected to low pass and high pass filters, allowing telephony and data (video) paths to be split and overlaid, as appropriate. Alternatively, VDSL or ADSL may employ QAM technology.

It would be desirable to harness these xDSL technologies and other high speed data transmission technologies to provide fast, flexible, efficient network connection to users clustered within a close proximity from each other.

### SUMMARY OF THE INVENTION

The present invention is directed to a network system designed to provide improved services to users. In one embodiment, a network system includes a plurality of integrated access devices (IADs) assigned to a plurality of clients in a multi-client unit (MCU). At least one IAD is assigned to each of the plurality of clients in the multi-client unit to transmit and receives units of information. The IADs is configured to prioritize data transmission according to the type of information included in the units of information. An MCU gateway device is assigned to the multi-client unit and coupled to the plurality of IADs to receive or transmit the units of information. The gateway device is configured to prioritize the units of information according to the type of information included in the units of information. A regional switching device is assigned to a geographic region including the MCU. The regional switching device is coupled to the gateway device to transmit or receive the units of information to and from the gateway device, wherein the unit of information is any block of data suitable for transmission from a first node to a second node in the network system.

The specific embodiments of the present invention disclosed below provide many benefits. For example, the network system enables a group of users to share bandwidth in order to more efficiently utilized the available bandwidth. The system provides clients (i.e., customers) to change their subscriber plans dynamically in real time. The system further enables each client to purchase different amount of bandwidth according to his or her needs. These and other benefits will become apparent to those skilled in the art upon reading the specific embodiments described below.

### BRIEF DESCRIPTION OF THE DRAWINGS

FIG. 1 is a schematic diagram of a network architecture of multi-client unit according to one embodiment of the present invention;

FIG. 2 is a schematic diagram of a gateway device of the network architecture shown in FIG. 1, according to one embodiment of the present invention.

FIG. 3 is a schematic diagram of a wide area network trunk card in the gateway device shown in FIG. 2, according to one embodiment of the present invention;

FIG. 4 is a schematic diagram of a line interface card in the wide area network trunk card shown in FIG. 3, according to one embodiment of the present invention;

FIG. 5A is a schematic diagram of a traffic regulator in the wide area network trunk card shown in FIG. 3, according to one embodiment of the present invention;

FIG. 5B is a schematic diagram of a record keeper in the traffic regulator of FIG. 5A, according to one embodiment of the present invention;

FIG. 5C is a flow chart depicting the steps performed by the traffic regulator in handling packets, according to one embodiment of the present invention;

FIG. 6 is a schematic diagram of a traffic shaper in the wide area network trunk card shown in FIG. 3, according to one embodiment of the present invention;

FIG. 7 is a schematic diagram of a routing device in the wide area network trunk card shown in FIG. 3, according to one embodiment of the present invention;

FIG. 8 is a schematic diagram of a switch card in the gateway device shown in FIG. 2, according to one embodiment of the present invention;

FIG. 9 is a schematic diagram of a line card in the gateway device shown in FIG. 2, according to one embodiment of the present invention;

FIG. 10 is a schematic diagram of an integrated access device of the network architecture shown in FIG. 1, according to one embodiment of the present invention;

FIG. 11 is a schematic diagram of a network architecture of multi-client unit according to another embodiment of the present invention; and

FIG. 12 is a schematic diagram of a network architecture of multi-client unit according to yet another embodiment of the present invention.

### DESCRIPTION OF THE SPECIFIC EMBODIMENTS

The present invention is directed to a network architecture which allow a group of users to share communication infrastructure. The figures and description provided herein are merely illustrations and should not limit the scope of the present invention. One of ordinary skill in the art would recognize other variations, modifications, and alternatives.

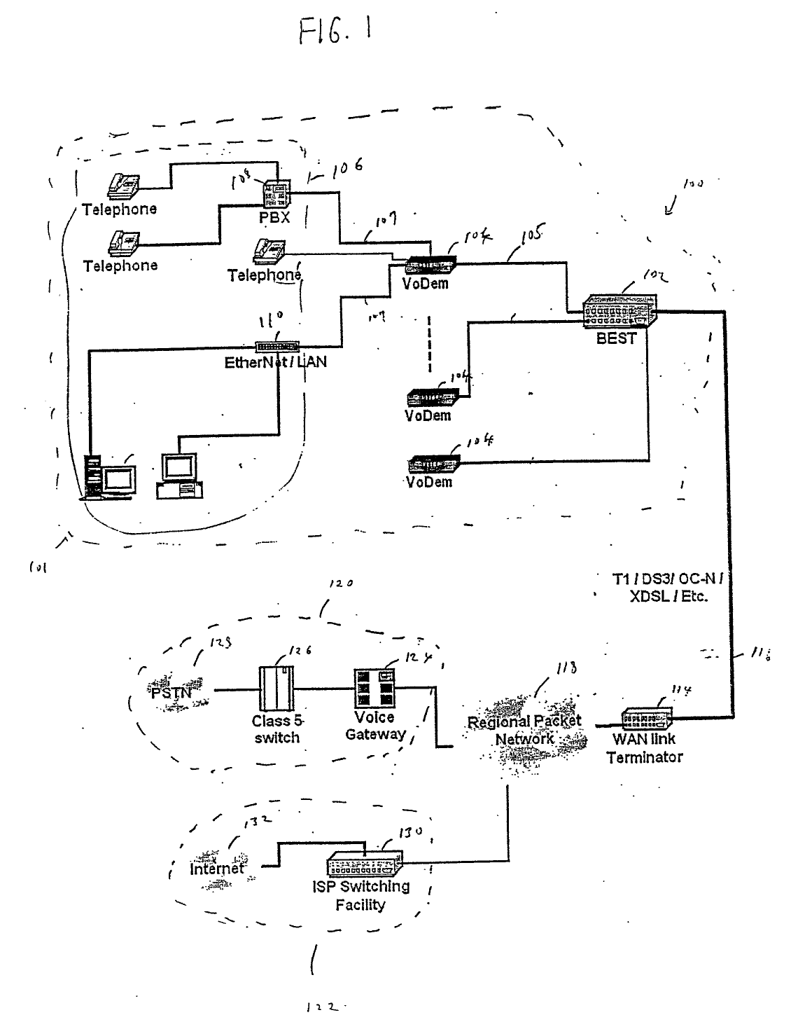

FIG. 1 illustrates a schematic diagram of a network architecture 100 for multi-client units according to one embodiment of the present invention. As used herein, the multi-client unit (“MCU”) refers to a multi-tenant unit, multi-business building, business park, school campus, and the like, where a plurality of clients exists within an area close enough to share a common gateway device. Network architecture 100 includes a plurality of smart shared real estate gateway devices 102. Each gateway device 102 is provided at a multi-client unit or MCU 101 or a close proximity thereto to serve as a primary interface to the outside world, as explained in more details later. As used herein, the term “close proximity” refers to a distance which is not great enough to prevent the gateway device from being connected to the client equipment, presently within about 3000 feet when VDSL technology is used for the specific embodiments described herein. As one of ordinary skill in the art would recognize, this distance would vary depending on a particular technology (e.g., VDSL, RDSL, or ADSL) and data rate implemented for the network architecture 100, as well as the improvements made on such a technology.

Within the MCU, a plurality of improved integrated access devices (“IAD”) 104 are coupled to the SRE gateway device via local loops or lines 105. Generally, each IAD 104 is provided for each client within the MCU. The client may be a single end-user or a business entity with multiple end-users. In one embodiment, lines 105 are a pair of twisted copper wires, and xDSL technology (e.g., VDSL) is used to transmit data to and from the gateway device and IAD 104. Alternatively, lines 105 may be fiber optics, coax cable, and the like. In some instances, lines 105 have a combination of the above, where one link between the IAD and the gateway device for one client is of one type, e.g., twisted copper wires, and another link for another client is of another type, e.g., fiber optics. The IAD serves as a secondary gate keeper to the outside world and cooperates with gateway device 102 to transmit or receive data, as explained in more details later.

The IAD is coupled to a client or customer premise equipment (“CPE”) 106 such as telephone stations, facsimile machines, multimedia equipment, personal computers, and the like via lines 107. In one embodiment, each of lines 107 is a pair of twisted copper wires. Alternatively, they may be fiber optics, coax cable, and the like. The CPE such as telephone stations or facsimile machines may be coupled directly to IAD 104 or indirectly to IAD 104 via a private branch exchange system (“PBX”) 108. PBX system 108 is an on-premise exchange system which can be coupled to multiple incoming and outgoing trunk lines and multiple telephone sets within an office. Likewise, the CPE such as personal computers, facsimile machines, and the like, may be coupled directly to IAD 104 or indirectly to IAD 104 via a local area network (“LAN”) 110. LAN 110 generally connects a plurality of end users to each other in a network and to wide area network such as the Internet.

Referring back to the overview of the network architecture, gateway device 102 is coupled to a WAN link terminator 114 via a communication interface 116 which can be T1/E1/IMA, xDSL, DS3, OC-N, point-to-point, point-to-multipoint, wireless, and the like. The gateway device is configured to operate with any one of these communication interfaces, as explained later herein. WAN link terminator 114 determines whether the information received from the SRE gateway device is a voice, video, or data packet. Generally, this determination is made by checking a particular information in the header of each packet that indicates whether the packet contains voice, video, or data information. As used herein, the word “data” used alone refers to information in generic sense and encompasses voice, video, or data packets. The words “data packets,” however, specifically refers to packets containing data other than voice or video information. The word “packets” refers to a block or unit of data, such as cells, packets, segments, and the like, formatted for transmission over a network, unless otherwise limited.

A regional packet network 118 is coupled to the WAN link terminator to receive the packet and transmits the packet to a voice network 120 or a data network 122, depending on the determination made by the WAN link terminator. Voice network 120 includes a voice gateway 124 which converts the data in the asynchronous transmission mode (“ATM”) format to the time division multiplex (“TDM”) format, a class-5 switch 126, and a PSTN 128. Data network 122 includes an ISP switching facility 130 which routes the packet to the Internet 132.

Network system 100 above provides clients with fast, flexible, and scalable data communication capability. Using gateway device 102 and IAD 104, a service provider can provide clients with numerous service features. Each client may purchase a different amount of bandwidth according to his or her needs. The clients may be provided with the ability to dynamically increase or decrease the amount of bandwidth purchased in real time. The data being transmitted or received by each client may be prioritized using various parameters to ensure that the higher priority information are generally transmitted before the lower priority information. Clients may be provided with different service plans, where some pays for only the actual amount of the bandwidth used in a particular billing period, where as others may sign onto a monthly plan for a specific amount of bandwidth. Yet other clients may be provided with a combination of the above two plans, where the clients sign on for a specific amount of bandwidth, and pay additional fees for the bandwidth used in excess of the purchased amount. The service provider may also provide the users with ability to direct a telephone call to either PSTN or Internet/VPN on a per-call basis, ability to send facsimile transmission over the Internet, ability to create “user affinity groups” whereby a MCU owner/manager can direct traffic from a group of users to a chosen set of ISPs/CLECs/ICPs over a bigger pipe with higher quality of service than individual links and, ability to create “service provider affinity groups” whereby a voice CLEC can partner with an ISP and provide bundled services. As the gateway device and IAD 104 are described in greater details below, it will become apparent to one skilled in the art that system 100 may be used to provide services other those described above.

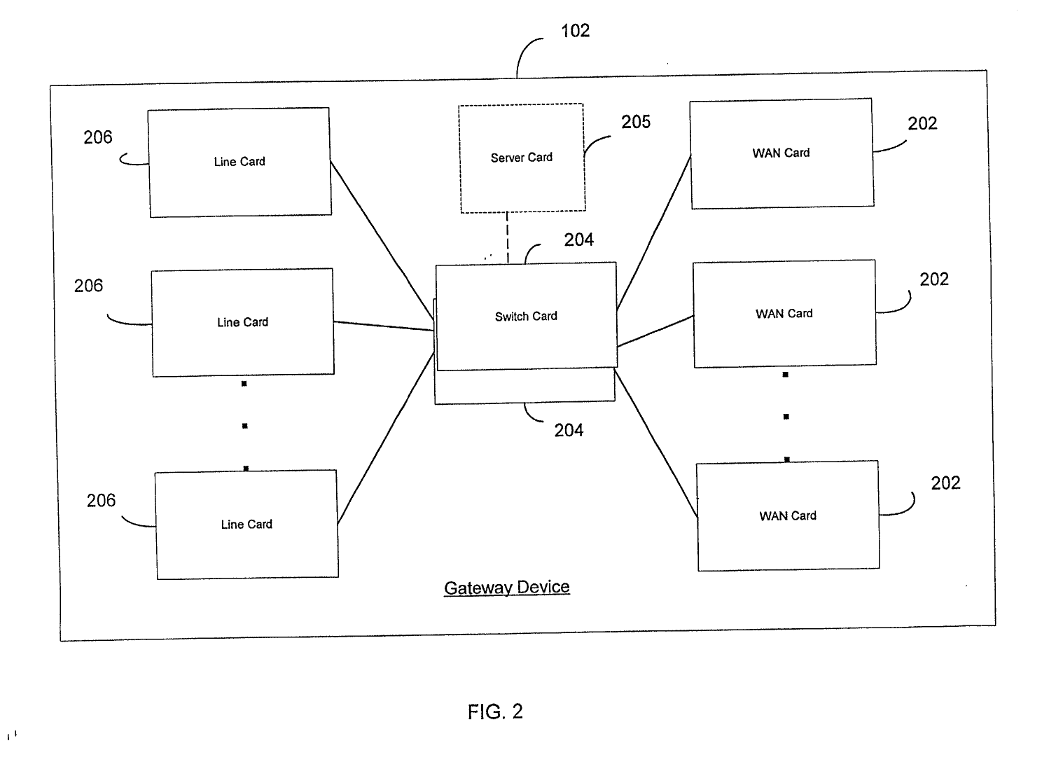

Referring to FIG. 2, gateway device 102, according to one embodiment of the present invention, includes a plurality of wide area network (“WAN”) trunk cards 202, one or more switch cards 204, and a plurality of line cards 206. In one embodiment, gateway device 102 includes two switch cards 204, where only one (i.e., primary switch card) stays active and the other (i.e., redundant switch card) remains inactive or idle under normal condition. The redundant card is activated when the primary card either goes out of service unexpectedly or is placed out of service temporarily for maintenance, upgrade, and the like. In one embodiment, two or more switch cards may be used together to handle heavy data traffic between the WAN and line cards. Yet in another embodiment, gateway device 102 includes a server card 205 which performs all calculation intensive functions such as packet arbitration, designation of data route for each packet, or the like. The server card may further perform services relating to providing firewall, virtual private network, encryption, dynamic host control protocol, network address translation, and the like, so that these services and program can be performed at a centralized location at gateway device 102 for the clients in the MCU, rather than having each client run its own programs at its site.

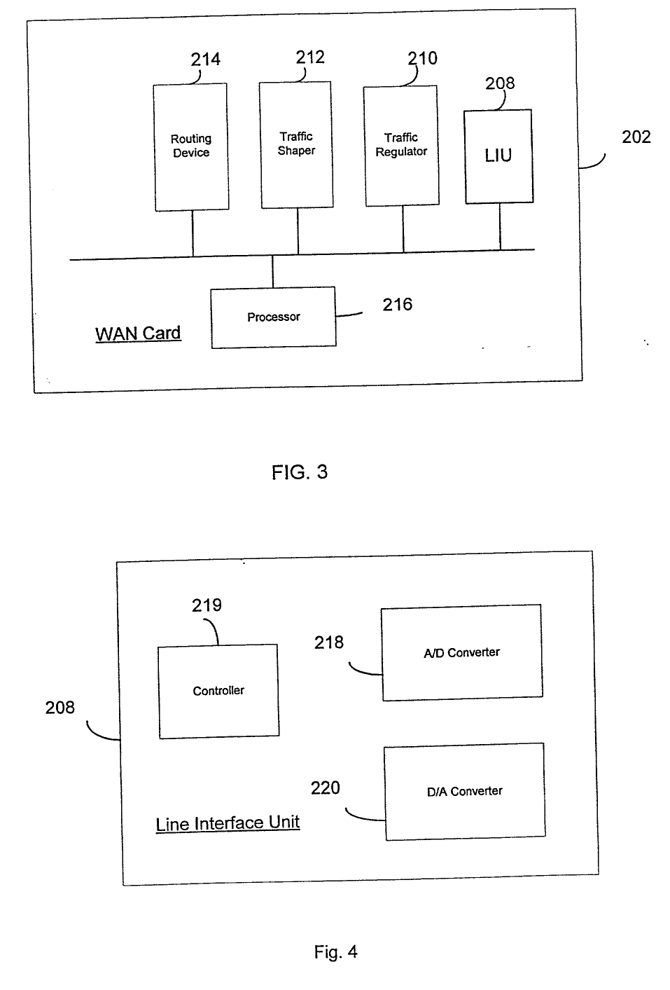

Referring to FIGS. 2 and 3, the WAN trunk cards are coupled to communication line 116 in order to receive data from and transmit data to a node in system 100. Generally, each WAN card 202 is dedicated to a particular communication technology, such as OC3, OC12, OC48, T1, T3, E1, or the like. In some instances, the WAN card may be configured to interface with two or more technologies. Yet in other instances, two or more WAN cards 202 may be dedicated to one particular technology. The plurality of WAN cards 202 may be configured to serve as redundant cards, so that if one or more cards are out of service, the remaining WAN card or cards may continue to provide services without interruption (perhaps at lower bandwidth) to the clients at the MCU.

WAN card 202 includes a line interface unit 208 which interfaces with communication link 116, a traffic regulator 210 which regulates the data flow into and out of the gateway device, a traffic shaper 212 which prioritize data to be handled by the gateway device, a routing device 214 which interfaces with switch card 204, and a WAN processor 216 which controls the operation of WAN card 202. These devices all handle both inward-bound data and outward-bound data, where the inward-bound data refer to data transmitted from a source node in system 100 to MCU 101, and the outward-bound data refer to data to be transmitted from IAD 104 or MCU 101 to a destination node in system 100. In one embodiment, these devices each has one set of components dedicated for handling inward-bound data and another set of components for handling outward-bound data.

Referring to FIG. 4, line interface unit (“LIU”) 208 includes an analog-to-digital (A/D) converter 218 for inward-bound data, a digital-to-analog (D/A) converter 220 for outward-bound data, and a controller 219. The AID converter receives incoming analog signals from line 116 and converts them to digital signals for handling in gateway device 102 and IAD 104. Similarly, the D/A converter receives outgoing digital signals from traffic regulator 210 and converts them to analog signals to be transmitted to destination nodes via line 116. Controller 219 configures the LIU to match the far-end signal encoding style, detects loss of signal and loss of frame conditions, monitors the conditions of the interface card in terms of signal to noise ratio, and the like.

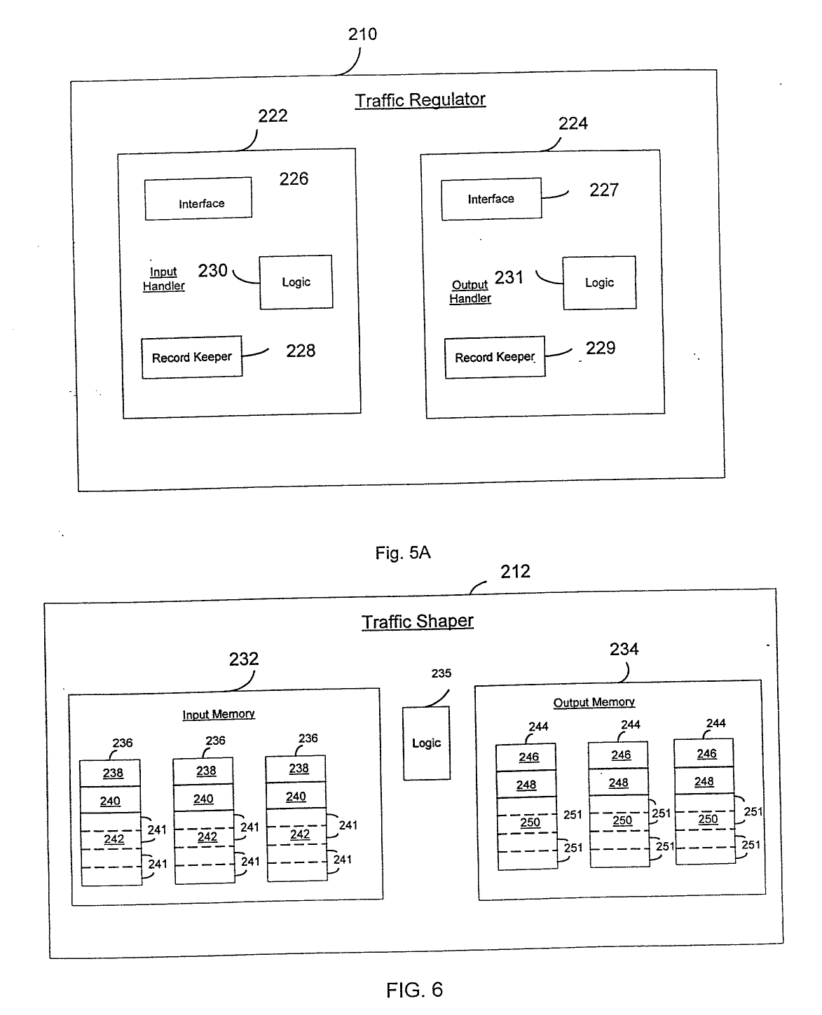

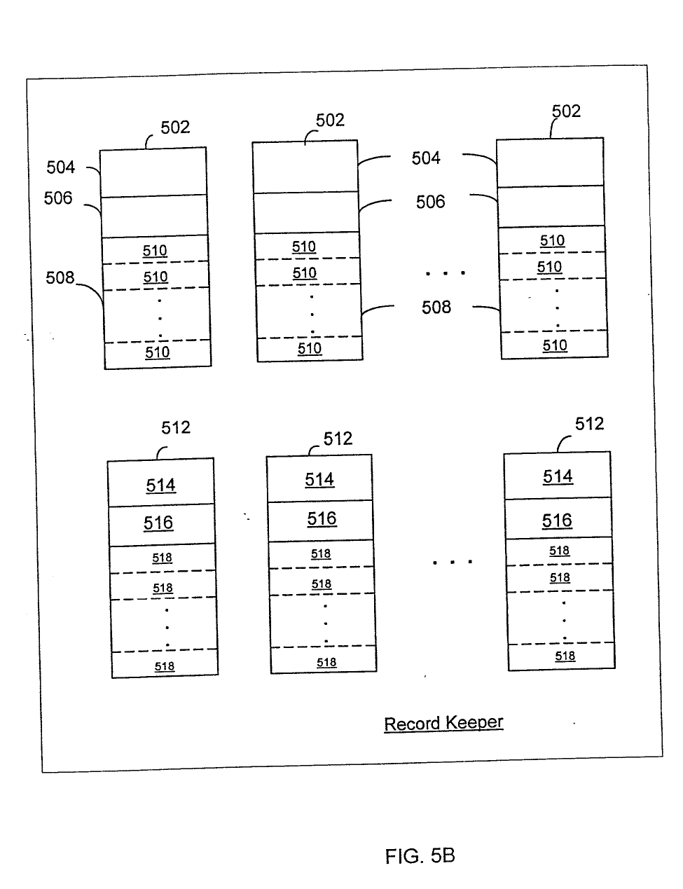

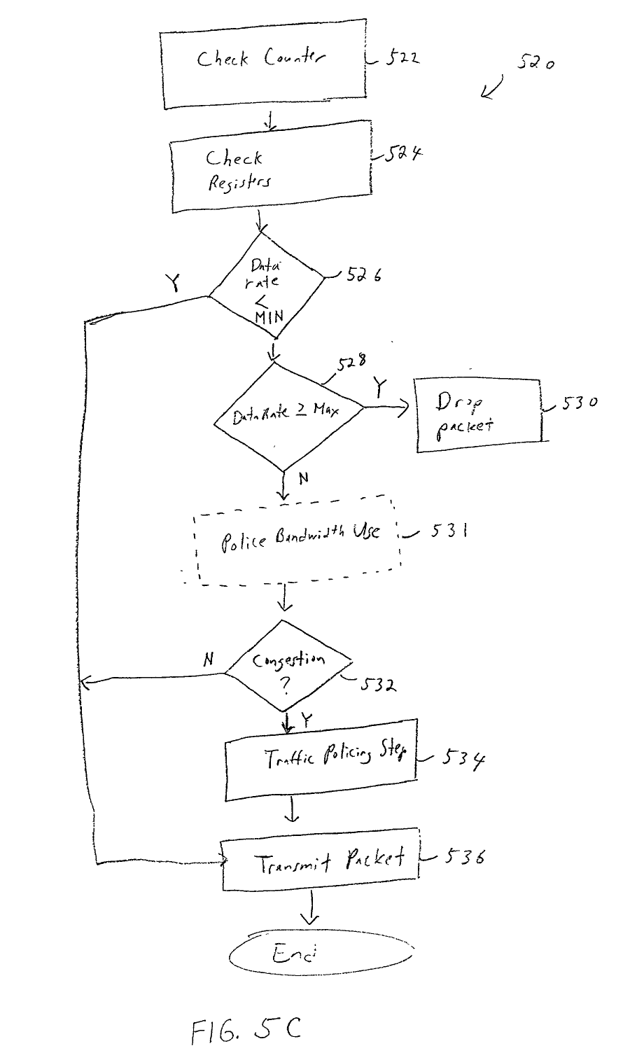

Referring to FIG. 5A, traffic regulator 210 regulates data flow in the WAN card by determining which packets to drop if any. The traffic regulator includes one or more input data handlers 222 and one or more output data handlers 224. The input data handlers receive data from the LIU and forward the data to appropriate IADs 104. The output data handlers receive data from IADs 104 and forward the data to the destination nodes in system 100. In one embodiment, the traffic regulator has one input data handler 222 and one output data handler 224 to handle all inward-bound data and all outward-bound data, respectively.

The input data handler includes an interface 226 to receive data, a record keeper 228 to keep track of the amount of bandwidth available to the client, and a logic 230 to control the interface. Interface 226 receives packets, i.e., voice, video, or data packets, from the LIU and either transmits or drops the packets received according to instructions of logic 230. The logic controls the interface with assistance of record keeper 228.

Referring to FIG. 5B, in one embodiment, the record keeper includes a plurality of data rate determiners 502 and a plurality of data rate table 512. Generally, the number of tables and determiners equal to the number IADs associated with the record keeper, so that each IAD is assigned one determiner 502 and one table 512.

Each data rate determiner 502 includes a voice counter 504 to determine the client's current data rate for voice packets, a video counter 506 to determine the client's current data rate for video packets, and a data counter 508 to determine the client's current data rate for data packets. The data counter includes a plurality of sub-counters 510 to determine the client's current data rate for different classes of data packets.

Each data rate table 512 includes a set of voice registers 514, maximum, minimum, and average data rate registers, to store information as to the maximum, minimum, and average voice data transmission rates purchased by the client and a set of data registers 516, maximum, minimum, and average data rate registers, to store information as to the maximum, minimum, and average video data transmission rates purchased by the client. Each table 512 further includes a set of data registers 518 for the packets of each data class. The set of data registers, maximum, minimum, and average data rate registers, store information as to the maximum, minimum, and average data transmission rates purchased by the client for a particular class of data packets. The data rate determiner and the table are used together to determine the amount of bandwidth available to the clients. The amount of bandwidth available to the client is the difference of the amount of bandwidth purchased and the amount of bandwidth already used by the client.

The data packets are generally categorized into a plurality of different classes, e.g., eight classes, according to the type of data the packets contain. For example, packets containing file transfer information or FTP are classified as class one (C1), packets containing email are classified as class two (C2), packets containing data sent or requested by some people are classified as class three (C3), packets containing data sent or requested by another group of people are classified as class four (C4), packets transmitted to a particular destination are classified as class five (C5), packets transmitted to another destination are classified as class six (C6), packets transmitted at a particular time are classified as class seven (C7), and packets transmitted at another time is classified as class eight (C8). In addition, the packets may be classified into a particular class based on a combination of the factors. For example, packets containing data transmitted to Intel by Senior Software Manager Subrata Baneijee on Fridays between 2 to 4 P.M. may be designated as C1 data packets.

The above packet classification criteria are merely provided as exemplary criteria. Many other criteria may be used to classify the data packets. In one implementation, the clients may provide their own packet classification criteria according to their needs. Therefore, different clients may classify the same data type into different classes or may even have entirely different classification guidelines from one another.

This packet classification system may be used to prioritize the packets to appropriately allocate the available bandwidth. In one implementation, each of these different classes of packets may be given a different priority level. In another implementation, two or more classes of packets may be given the same priority. Generally, the packets are prioritized according to the ascending order of the classification number. For example, C1 packets is given higher priority over C2 packets which in turn is given higher priority over C3 packets, and so on. The clients, however, may have the flexibility to prioritize the packets according to their own needs. For example, a client may reconfigure the priority of packets, so that C1 packets continues to have priority over C2 packets, but C3 packets are given priority over C2 packets.

In one embodiment, all packets including voice and video packets are classified into particular classes, so that the packets are arbitrated and prioritized based solely on the packet classification, rather than on whether the packets contain voice, video, or data information. For example, voice packets to and from a particular person may be classified as C1 packet, voice packets to and from another person may be classified by as C2 packets, video packets to and from a person may be classified as C3 packets, video packets to and from another person may be classified as C4 packets, data packets containing email may be classified as C5 packets, data packets containing email of a particular person may be classified as C6 packets, data packets containing email of a particular person that are sent out at a particular time and to a particular company may be classified as C7 packets, and so on. As in other embodiments, the packets containing time-critical information, e.g., voice and video information, may be given priority over the packets containing non-time-critical information, e.g., typical data information, by appropriately classifying the former packets into high priority packet classes.

All packets, i.e., voice, video, and data packets, are generally assigned maximum, minimum, and average data rates according to the service plans purchased by the clients. The maximum data rate is generally the highest allowed data rate for a given packet type. However, the maximum data rate may be a “soft ceiling” so that the data rate may exceed the maximum data rate under certain circumstances. The minimum data rate is generally the minimum guaranteed data rate for a given packet type. The minimum data rate may also be a “soft” limit under certain circumstances. The average data rate is an average rate of data transmission over a given duration. Different packet types or different classes of packets may be assigned different maximum, minimum, and average data rates according to the client's needs. For example, the voice packets and video packets may be assigned different maximum, minimum, and average data rates, respectively. Data packets of different classes may be assigned different maximum, minimum, and average data rates. In some instances, even the packets of the same type or class may be assigned different maximum, minimum, and average data rates. For example, the packets of the same type or class may be given different maximum, minimum, and average data rates depending on whether the packet is in-ward bound or outward-bound data.

FIG. 5C illustrates a process 520 which depicts some of the steps performed by the traffic regulator according to one embodiment of the present invention. When an inward-bound packet is received at the interface of the input data handler, logic 230 determines the packet type and accesses the appropriate counter (step 522). The counter provides the current data rate for that packet type. The logic also checks the maximum, minimum, and average data rate registers for that packet type to determine its maximum, minimum, and average data rates (step 524). If the current data rate is less than the minimum data rate, then the logic instructs the interface to transmit the packet to traffic shaper 212 (steps 526 and 536). If the current data rate exceeds the minimum data rate, logic 230 determines if the current data rate has reached or exceeded the maximum data rate (step 528) If so, the logic instructs the interface to drop the packet. If not, the logic checks to see if there is a congestion at the traffic shaper (step 532). If there is no congestion, the packet is transmitted. If congestion exists, the packet is temporarily stored in the interface or a storage space remote from the interface, so that a traffic policing step can be performed (step 534).

Under the traffic policing step, the packet is temporarily stored, e.g., in the interface, until the congestion is alleviated. However, if another packet arrives at the interface while the previous packet is waiting to be transmitted, logic 230 decides which packet to drop. Generally, the packets of those clients who are exceeding their average data transmission rate are dropped first. Also, when two packets with different priority levels are in contention, the one with lower priority is generally dropped. In some implementations, a plurality of packets, e.g., ten or more packets, may be store temporarily in the interface, so that the logic would have to decide which packet to drop from these plurality of packets.

In one embodiment, the maximum, minimum, average rate registers for the input handlers may be set dynamically, i.e., in real time, in order to provide clients with ability to adjust the amount of bandwidth purchased at any time and effectuate the adjustment immediately.

In addition to different amounts of bandwidth, clients may purchase different levels of service. For example, clients may chose from three different levels of service: platinum, gold and silver. During the traffic policing step, the logic may be instructed to drops the packets of clients having lower level of service first before dropping the packets of clients having higher level of service. If two packets of equal priority levels are in contest over the bandwidth, the packets of clients with higher levels of service may also be given higher priority over the packets of clients with lower levels of service, as explained in more details later in connection with traffic shaper 212.

In one embodiment, the traffic regulator can optionally police the bandwidth use of the clients so that a client does not consistently exceed the average data transmission rate (step 531). If the traffic regulator detects a client exceeding his or her average data rate, the client is promptly notified of the excessive bandwidth use and is given an opportunity to purchase more bandwidth. Thereafter, if the client does not purchase more bandwidth and continues to transmit data at rates exceeding the average data rate, the traffic regulator can commence dropping packets to bring the client in line with the actual amount of bandwidth purchased.

As with the input handler, the output data handler includes an interface 227 to receive outward-bound data, a record keeper 229 to keep track of the amount of bandwidth available to the clients, and a logic 231 to control the interface. Interface 227 receives packets, i.e., voice, video, or data packets, from the traffic shaper and either transmits or drops the packet received according to instructions of logic 231. The logic controls the interface with the assistance of record keeper 229. The record keeper includes a plurality of primary counters and maximum, minimum, and average data rate registers that can be set dynamically, as described above. In one embodiment, the operation of the output handler is similar to that of the input handler, and as such will not be described herein. In other embodiments, the operation of output handler may be substantially different from that of the input handler.

In one embodiment, traffic regulator 210, e.g., using logics 230 and 231 and record keepers 228 and 229, maintains data transmission information, such as the frequency of packets being dropped, types and percentages of packets being dropped, average data transmission rate, etc. The clients may be provided with a periodic report, e.g., monthly report, of this data transmission information to adjust the subscriber plan accordingly, e.g., to increase or decrease the bandwidth being purchased. The clients may purchase more bandwidth for a fixed time, e.g., for ten minutes, ten hours or ten days, or simply purchase more bandwidth indefinitely. The periodic report may also be used to provide clients with an option of being billed for the amount of bandwidth actually used. The report can also be used to charge additional fees to the clients who have used more bandwidth than they had actually purchased. In addition, the clients may also be notified in real time if a certain situation occurs, e.g., the frequency of the packets being dropped exceeds an acceptable level. This may be provided in a periodic report or immediately via email upon occurrence of the situation. When notified, the client would have an opportunity to immediately purchase more bandwidth to solve the bandwidth shortage or take other actions to resolve the problem notified.

In addition to the traffic regulator, traffic shaper 212 plays an important role within the gateway device in controlling the data flow. The traffic shaper ensures higher priority packets are given priority over lower priority packets during data transmission. Referring to FIG. 6, the traffic shaper includes an input memory 232 to store packets to be forwarded to end users at IAD 104, an output memory 234 to store packets to be forwarded to destination nodes in system 100, and a logic 235 to communicate with processor 216.

The input memory includes a plurality of primary queues 236, one for each IAD coupled to the gateway device, to temporarily store packets in a queue corresponding to the IAD to which the packet is directed. Each queue 236 includes a voice queue 238 to store voice packets, a video queue 240 to store video packets, and a data queue 242 to store data packets. The data queue, in turn, has a plurality of sub-queues 241. In one implementation, each sub-queue stores a particular class of data packets, so that the data packets of different classes are stored in different sub-queues. In another implementation, each sub-queue stores data packets of a particular priority level, so that the data packets of the different priority levels are stored in different sub-queues. In such a case, a sub-queue may store the data packets of different classes if they have the same priority level. The data packets are categorized into different priority levels: very high, high, medium, and low. The data packets with higher priority level are generally given priority over those with lower priority level during arbitration of data transmission. As with the input memory, the output memory includes a plurality of primary queues 244, each having a voice queue 246, a video queue 248, and a data queue 250. Data queue, in turn, has a plurality of sub-queues 249. Sub-queues 249 may store various data packets separately according to their classes or priority levels.

In one embodiment, the memory size of primary queues 236 and 244 corresponds to the amount of bandwidth purchased by clients, so that those who have purchased more bandwidth are provided with more memory space. The memory space for primary queues 236 and 244 are divided among the voice, video, and data queues. The memory size of primary queues 236 and 244 may be used as one method of managing the data flow, so that each client is provided with the bandwidth corresponding to the amount of bandwidth actually purchased by the client. For example, if a client purchases a small amount of bandwidth and is provided with queues 238, 240, and 242 having little memory space, the queues would be filled quickly and the packets stored in the queues are more likely to be dropped as more packets are received thereafter, thereby decreasing the amount of bandwidth made available to the client. On the other hand, if a client purchases a large amount of bandwidth and is provided with the queues having large memory space, the queues would not fill as quickly; consequently, the packets would be less likely to be dropped, thereby increasing the amount of bandwidth made available to the client.

Generally, the memory space for the primary queues may be allocated to the voice, video, and data queues according to the needs of clients. In one embodiment, as a default configuration, 15 percent, 25 percent, and 60 percent of the memory space are allocated to the voice, video, and data queues, respectively. This default configuration may be adjusted by a client according to his or her needs. For example, one client who relies heavily on telephone to conduct his or her business may allocate a large portion of the available memory, e.g., 70 percent, to the voice queue and evenly divide the remaining memory between the video and data queues. In contrast, another client who does not use telephone very much may allocate a small portion of the memory, e.g., ten percent, to the voice queue.

As explained above, traffic shaper 212 arbitrates between packets waiting to be transmitted to ensure those with higher priority are generally transmitted before those with lower priority. In one embodiment, voice packets are given first priority, video packets are given second priority, and data packets are given third priority. The data packets, in turn, are identified into four different priority levels. In one embodiment, the procedure to used to transmit packets are similar for both the inward-bound data received from the traffic regulator and the outward-bound data received from the routing device. Therefore, the procedure used to transmit the inward-bound data is representatively described below. In other embodiments, substantially different procedures may be used to transmit the inward-bound data and the outward-bound data.

When transmitting inward-bound data received from the traffic regulator to the routing device, logic 235 generally first checks voice queues 238 since the voice queues have the first priority. If the voice queues contain packets, these are transmitted one at a time by accessing one voice queue at a time in a round robin fashion until all of the voice packets have been transmitted or a predetermined time allotted for voice-packet transmission has expired, whichever occurs first. If all of the voice packets have been transmitted before the predetermined time has expired, logic 235 moves on to the video queues. On the other hand, if the predetermined time has expired and there are still additional voice packets waiting to be transmitted, logic 235 check the video and data queues to determine whether they have any packets waiting to be transmitted. If so, logic 235 moves onto the video and data queues in sequence to transmit the packets stored therein. If not, logic 235 continues to transmit the voice packets and the steps above are repeated. Alternatively, the logic may continue to transmit the voice packets until it is notified that video packets or data packets, or both, have been received.

Logic 235 is programmed to check for video and data packets to be transmitted after the predetermined time so that video and data packets would be guaranteed minimum transmission rate. Otherwise, if there is a steady stream of enough voice packets, the video and data packets would never be transmitted. In addition to the round robin method, a “proportional access method” may be used, where the voice queues is accessed in proportion to the amount of bandwidth purchased by clients. For example, if client A and client B have purchased eight Mbps and four Mbps of upstream data transmission rate, respectively, logic 235 would access the voice queues in a round robin fashion but the voice queue assigned to client A would be granted twice the transmission time as the voice queue assigned to client B. Alternatively, the voice queue assigned to client A may be accessed twice as often as the voice queue assigned to client B.

Once the voice packets have been transmitted, logic 235 checks video queues 240. If the video queues contain packets, these are then transmitted one at a time by accessing each video queue in the primary queues in a round robin fashion until all of the voice packets have been transmitted or a predetermined time allotted for video-packet transmission has expired, whichever occurs first. If all of the video packets have been transmitted before the predetermined time has expired, logic 235 moves on to the data queues. On the other hand, if the predetermined time has expired and there are still additional video packets waiting to be transmitted, logic 235 check the data and voice queues to determine whether either queue has any packets waiting to be transmitted. If so, logic 235 accesses the voice and video queues to transmit the packets stored therein. If not, logic 235 continues to transmit the video packets and the steps above are repeated. Alternatively, the logic continues to transmit the video packets until it is notified that voice packets or data packets, or both, have been received.

As with the voice-packet transmission, logic 235 is programmed to check the data and voice queues after transmitting the video queues for the predetermined time so that data packets would be guaranteed minimum transmission rate. In addition to the round robin method, the proportional access method may be used to transmit the video packets.

Once the video packets have been transmitted, logic 235 checks data queues 242. If the data queues contain packets, these are then transmitted one at a time by accessing one data queue at a time in a round robin fashion until all of the data packets have been transmitted or a predetermined time allotted for data-packet transmission has expired, whichever occurs first. When checking the data queues 242, the logic first accesses the sub-queues containing very high priority packets, then the sub-queues containing high priority packets, thereafter the sub-queues containing medium priority packets, and finally the sub-queues containing low priority packets. The logic provides each sub-queue with a sufficient access time to guarantee the predetermined minimum data rates of the data packets of all types. If all of the data packets have been transmitted before the expiration of the predetermined time, logic 235 moves back to the voice queues. On the other hand, if the predetermined time has expired and there are still additional data packets waiting to be transmitted, logic 235 check the voice and video queues to determine whether they have any packets waiting to be transmitted. If so, logic 235 accesses the voice and video queues to transmit the packets stored therein. If not, logic 235 continues on to transmit the data packets, and the above steps are repeated. Alternatively, the logic may continue to transmit the data packets until it is notified that voice packets or video packets, or both, are received at the respective queues.

As with the voice-and-video-packet transmissions, logic 235 is programmed to transmit data packets for no more than the predetermined time so that voice and video packets would be granted additional transmission time. In addition to the round robin method, the proportional access method may be used to transmit the data packets. The packet arbitration methods above have been described merely to illustrate an exemplary method; therefore, they should not used to limit the scope of the invention in anyway. Many other methods of arbitration may be used to transmit the packets in implementing the embodiments of the present invention.

In another embodiment, as explained in connection with the traffic regulator, clients may purchase different levels of service: platinum, gold and silver. When accessing the same type of queue, e.g., voice queues, the queues of clients that had purchased the platinum service will be first transmitted, then the queues of those who had purchased the gold service, and finally the queues of those who had purchased the silver service. When arbitrating between the queues of those who had purchased the same level of service, an appropriate arbitration method including those described above may be used.

In one embodiment, a client may reconfigure the priorities of packets. For example, one client may designate video packets as first priority, voice packets as second priority, and data packets as third priority, so that video packets are given priority over the voice and data packets. Another client may designate data packets as first priority, video packets as second priority, and voice packets as third priority, so that data packets are given priority over the video and voice packets. Alternatively, a client may designate voice packets and video packets to have the same priority, where they will be given equal priority during transmission arbitration. One way of reconfiguring the packet priorities is by enabling the clients to classify the packets into different classes according to their own guidelines without considering whether the packets contain voice, video, or data information. In this way, the clients may categorize the packets containing important or time-critical information into classes having high priority and packets containing less important or non-time-critical information into classes having low priority.

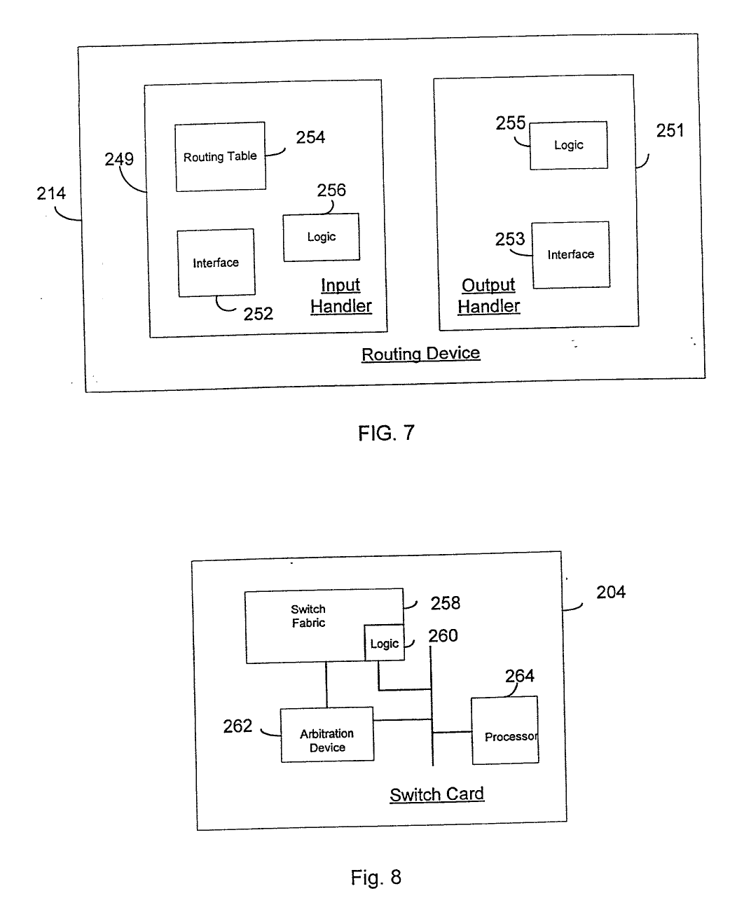

Referring to FIGS. 3 and 7, routing device 214 receives inward-bound packets from and transmits outward-bound packets to the traffic shaper. The routing device includes an input handler 249 to handle inward-bound data and an output handler 251 to handle outward-bound data. The input handler includes an interface 252 to receive packets, a routing table 254 to store routing information, and a logic 256 to control the interface. The output handler includes an interface 253 to receive packets and logic 255 to control the interface.

When handling inward-bound data, logic 256 examines the header of the packet received at interface 252 to determine the destination address of the packet. Using this address, logic 256 then looks up the routing table 254 to determine the appropriate line card to route the packet. Logic 256 adds an additional header information or extra header to the packet and transmits it to the switch card. The additional header information identifies the appropriate line card to which the packet is to be routed by the switch card and the priority of the packet. The priority information includes one or more of the following: the packet type (e.g., voice, video, or data packet), the packet class, or the level of service purchased by the recipient of the packet. On the other hand, when handling outward-bound data, logic 255 instructs interface 253 to drop or transmit the packet received. Generally output handler does not include a routing table since all outward-bound packets are transmitted to the same destination, i.e., the traffic shaper of the WAN card to which the routing device is located.

Referring back to FIG. 3, WAN processor 216 communicates with line interface unit 208, traffic regulator 210, traffic shaper 212, and routing device 214. The processor also maintains communications with other processors in the gateway device. Processor 216, therefore, allows traffic regulator 210 and traffic shaper 212 to adjust its operations in real time according to the requests from the clients. For example, if a client requests to purchase additional bandwidth for the next two hours, this request is forwarded to processor 216 which communicates with the traffic regulator to implement the request. Other adjustment of services such as upgrading the level of service from the gold service to the platinum service can be implemented in real time as well.

Referring to FIGS. 2 and 8, switch card 204 routes the data received from routing device 214 of the WAN card to the appropriate line cards 206, or routes the data received from the line cards 204 to the appropriate WAN cards. Although only one switch card is shown, the gateway device generally has two or more switch cards for various reasons. For example, the extra switch card may be provided as a redundant card to be used when the primary switch card malfunctions.

The switch card includes a switch fabric 258 which receives packets from the plurality of WAN cards 202 and routes the packet to appropriate line card 206. The switch fabric generally includes a logic 260 which examines the additional header information (extra header) added by routing device 214 to determine the priority of the packets and the appropriate line cards 206 to which the packets are to be routed. Logic 260 uses the priority information to decide which packets to transmit first. The switch card also includes an arbitration device 262 to control the routing mechanism of the switch fabric. A switch processor 264 controls the operations of the components of the above. The switch processor also communicates with the processors in the WAN card and line card. In one embodiment, the switch processor has the primary responsibility of communicating with clients. All data relating to client service information, such as adding new users, adjusting the amount of bandwidth purchased, altering the guidelines in setting data priority, and the like, are first transmitted to the switch processor which then communicates with the appropriate devices to effectuate the requested services.

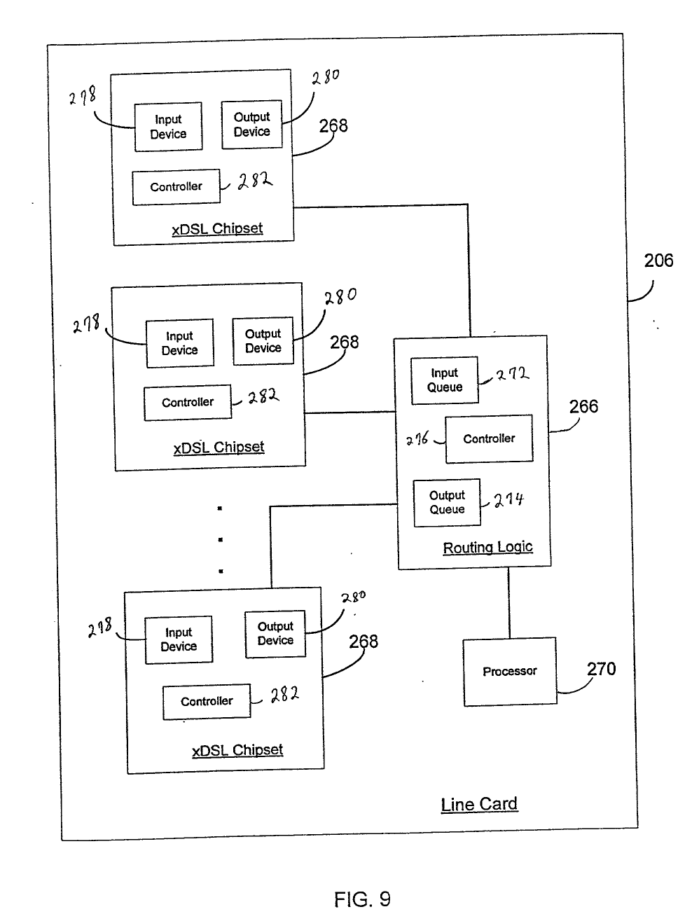

Referring to FIGS. 2 and 9, line card 206 includes a routing logic 266, a plurality of xDSL chipsets 268 that are paired to corresponding xDSL chipsets at the lADs, and a line card processor 270. In one embodiment, the xDSL chipsets are of VDSL technology. Alternatively, ADSL, RDSL, or other DSL chipsets may be used. In other embodiments, the chipsets of non-DSL technology may be used.

Routing logic 266 includes an input queue 272 to receive inward-bound packets from the switch card, an output queue 274 to receive outward-bound packets from the IADs, and a controller 276 to control the operation of the input and output queues. When handling inward-bound packets, controller 276 examines the extra headers of the packets received at the input queue to route the packets to the appropriate xDSL chipsets. Upon reading the extra headers, the routing logic removes them from the packets and transmits the packets to the appropriate chipsets. When handling outward-bound packets, controller 276 needs to arbitrate among the plurality of xDSL chipsets 268 that need to transmit the outward-bound packets to the routing device. Various arbitration methods may be used for this purpose. In one embodiment, the controller grants the transmission time to the plurality of chipsets in a round-robin method. Once the packets are received at output queue 274 in the routing device, the controller transmits the packets to the switch card in a first-in-first-out method.

Each xDSL chipset 268 includes an input device 278 to receive inward-bound packets from the routing logic, an output device 280 to receive outward-bound packets from the IAD, and a controller 282 to control the operations of the input and output devices. When handling inward-bound packets, the input device transmits the packets to the corresponding IAD under the controls of the controller. When handling outward-bound packets, the output device transmits the packets to the routing device under the controls of the controller 282.

Processor 270 controls the operations of the devices in the line card and communicates with processors 216 and 264 of the WAN and switch cards. Processor 270 may be used to perform the functions of the controllers 276 and 282 in some embodiments.

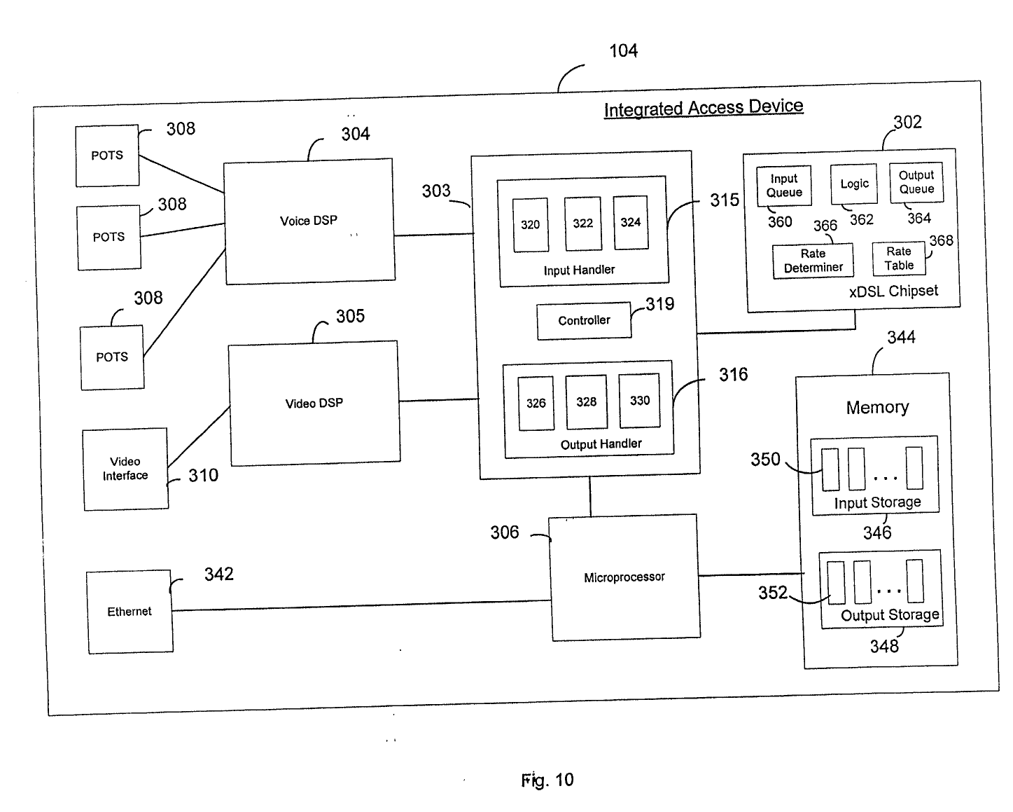

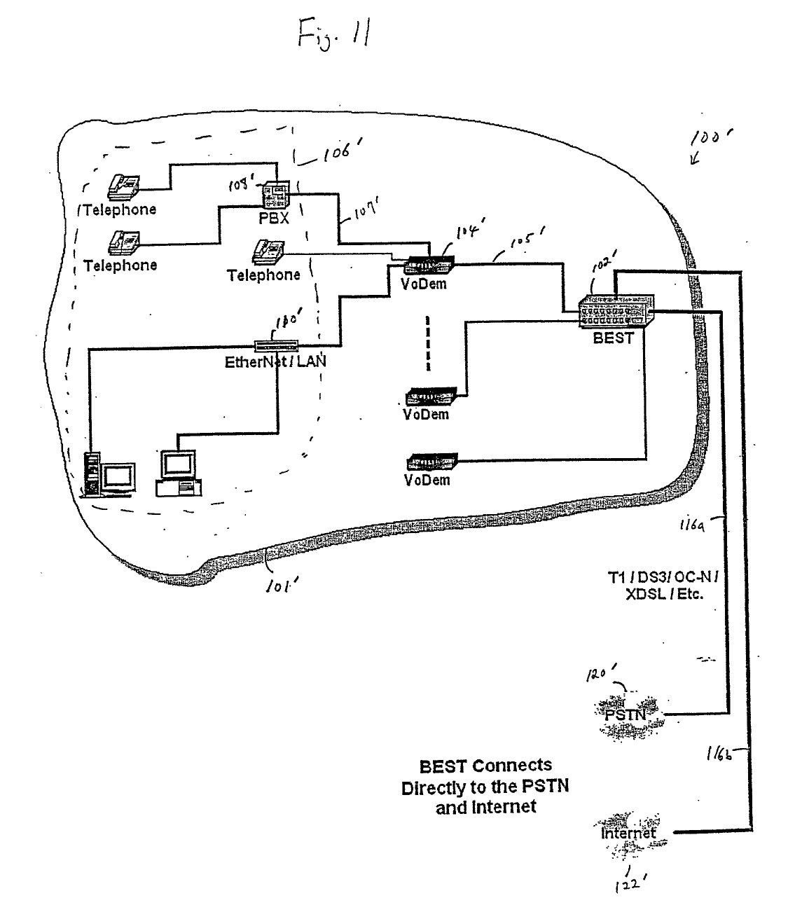

FIG. 10 illustrates a schematic diagram of IAD 104 according to one embodiment of the present invention. The IAD includes an xDSL chipset 302 to communicate with xDSL chipset 268 of the line card, a field programmable gate array or programmable logic device 303 to regulate data flow within the IAD, a voice digital signal processor (“DSP”) 304 to handle voice data, a video DSP 305 to handle video data, and a microprocessor 306 to handle non-voice and non-video data. Alternatively, a single DSP may be used to handle both voice and video data. The IAD, typically located at a client premise, cooperates with gateway device 102 to regulate the data flow at the MCU. More specifically, IAD 104 primarily regulates the data flow of a particular client to which it is assigned, whereas gateway device 102 regulates the data flow of all of the clients within a particular MCU. In one embodiment, the IAD interfaces with the gateway device through an ATM link using xDSL technology, e.g., VDSL technology. IAD 104 provides a plurality of subscriber interfaces for various applications including local area network (“LAN”), analog voice lines (FXS/FXO/DID), digital voice (DSX1), and video (V35).

xDSL chipset 302 serves as an interface between the IAD and the gateway device. xDSL chipset 302 is coupled to xDSL chipset 268 via line 105 to enable the IAD to transmit or receive data to and from gateway device 102. Line 105 is twisted copper wire in one embodiment of the present invention where xDSL technology is used to transmit data between the gateway device and the IAD. The maximum allowed length of line 105 vary depending on the type of DSL technology used for system 100. In another embodiment, fiber optics or other high speed connections may used for line 105.

Chipset 302 includes an input queue 360 to receive inward-bound packets, a logic 363 to control the input queue and other devices in the chipset, an output queue 364 to receive the outward-bound packets, a rate determiner 366 to determine the data transmission rates of various packets, and a rate table 368 to store the information as to the amount of bandwidth purchased by the client. The rate determinator includes a counter for voice packets, a counter for video packets, and a plurality of sub-counters for different classes of data packets, to determine the current data transmission rates for these packets. The rate table includes maximum, minimum, and average data rate registers for voice and video packets. The rate table also includes a set of registers, i.e., maximum, minimum, and average data rate registers, for each class of the data packets, where each set of registers stores the maximum, minimum, and average data rates for that class of data packets according to the service plan purchased by the client. In one embodiment, the rate determinator maintains data transmission rates only for outward-bound packets since the data transmission rates for the inward-bound packets are separately maintained in the gateway device, i.e., in the record keeper, as previously explained. Similarly, the rate table only maintains the information on the outward-bound bandwidth purchased by the client for the same reason. In other embodiments, the determinator and table may be provided for both the inward-bound and outward-bound packets. Yet in other embodiments, the determinator and table may be provided in a device other than the xDSL chipset 302, e.g., in programmable logic device 303.

In operation, the inward-bound packets from the gateway device are received at the input queue. The logic instructs the input queue to transmit the packets to the programmable logic device. On the other hand, the outward-bound packets from the programmable logic device are received at the output queue. As each packet is received from the logic device, a counter corresponding to the packet received is adjusted to reflect the current data rate for that packet type. Logic 362 checks a corresponding set of registers to determined the maximum, minimum, and average data transmission rates for that packet. If the actual data transmission rate has not exceeded the minimum transmission rate, the packet is automatically transmitted to the chipset in the gateway device. If the actual data transmission rate has exceeded the minimum data rate, logic 362 determines if whether the actual data transmission rate has reached or exceeded the maximum transmission rate. If so, the packet is dropped. If not, the packet is transmitted to the gateway device unless there the xDSL chipset detects congestion in the gateway device. While waiting for the congestion to alleviate, if another packet arrives at the output queue, the logic determines which of the two packets to drop. Generally, the packet that is exceeding its average data rate is dropped before the packet that is within its average data rate. Also, the packet that is of lower priority of the two is generally dropped. The logic may use other criteria to determine which packets to drop.

Programmable logic device 303 receives inward-bound data, i.e., voice packets, video packets, and data packets, from xDSL chipset 302, and routes them to voice DSP 304, video DSP 305, and microprocessor 306, accordingly. The logic device also receives outward-bound data, i.e., voice packets, video packets, and data packets, from voice DSP 304, video DSP 305, and microprocessor 306, respectively, and routes these data to xDSL chipset 302.

For these purposes, programmable logic device 303 includes an input handler 315 to handle the inward-bound data, an output handler 316 to handle the outward-bound data, and a controller 319 to control these two devices. Alternatively, a separate controller may be provided for the input and output handlers. The input handler includes a voice queue 320 to store voice packets, a video queue 322 to store video packets, and a data queue 324 to store data packets. In one implementation, all data packets are stored in the data queue in the order received at the logic device without regard to the priority level or the class type. The priority level and class type of data packets are considered for purposes of arbitration by microprocessor 306, as explained in greater detail subsequently. Similarly, the output handler includes a voice queue 326, a video queue 328, and a data queue 330.

In operation, logic device 303 arbitrates between packets waiting to be transmitted to ensure those with higher priority are generally transmitted before those with lower priority. As with traffic shaper 212, in one embodiment, the priority is given in the order of voice packets, video packets, and data packets. When handling inward-bound data, controller 319 first checks voice queue 320 since voice packets are generally given the first priority. If the voice queue contain packets, these are first transmitted one at a time using the first-in-first-out (FIFO) method until all of the voice packets have been transmitted or a predetermined time allotted for voice-packet transmission has expired, whichever occurs first. If all of the voice packets have been transmitted before the expiration of the predetermined time, controller 319 moves on to the video queue.

On the other hand, if the predetermined time has expired and there are still additional voice packets waiting to be transmitted, controller 319 check the video and data queues to determine whether either queue has any packets waiting to be transmitted. If so, controller 319 moves on to these queues to transmit packets stored therein. If not, controller 319 continues to transmit the voice packets, and the above steps are repeated. Controller 319 ensures that the transmission for voice packets does not exceed the predetermined time so that video and data packets would be respective guaranteed minimum transmission rates. Otherwise, if there is a steady stream of voice packets, video and data packets would never be transmitted.

Once the voice packets have been transmitted, controller 319 checks video queue 322. If the video queue contain packets, these are then transmitted one at a time using the FIFO method until all of the voice packets have been transmitted or a predetermined time allotted for video-packet transmission has expired, whichever occurs first. If all of the video packets have been transmitted before the predetermined time has expired, controller 319 accesses the data queue. On the other hand, if the predetermined time has expired and there are still additional video packets waiting to be transmitted, controller 319 checks the data and voice queues to determine whether they have any packets waiting to be transmitted. If so, controller 319 accesses the data and voice queues in sequence to transmit packets stored therein. If not, controller 319 continues to transmit the video packets, and the above steps are repeated. As with the voice-packet transmission, controller 319 ensures that the transmission for video packets does not exceed the predetermined time so that data packets would be guaranteed minimum transmission rate.

Once the video packets have been transmitted, controller 319 checks data queue 324, i.e., sub-queues 325. If the queues contain packets, these are transmitted one at a time via the output interface by FIFO method until all of the voice packets have been transmitted or a predetermined time allotted for data-packet transmission has expired, whichever occurs first. If all of the data packets have been transmitted before the expiration of the predetermined time, controller 319 returns to the voice queue. On the other hand, if the predetermined time has expired and there are still additional data packets waiting to be transmitted, controller 319 checks the voice and video queues to determine whether either queue has any packets waiting to be transmitted. If so, controller 319 moves on to the voice and video queues to transmit packets stored therein. If not, controller 319 continues to transmit the data packets and the steps above are repeated. As with the transmission of other packet types, controller 319 ensures that data packets are transmitted for no more than the predetermined time so that voice and video packets would be granted additional transmission time. Although the above description relates to handling inward-bound data, a substantially similar method to the above maybe used to handle outward-bound data, according to one embodiment of the present invention. In other embodiments, other arbitration methods may be used.

In one embodiment, the logic device may be programmed to reconfigure the default packet priority order for the client. For example, video packets may be given priority over voice packets for a particular client if he or she wishes. Alternatively, voice packets and video packets may be given equal priority, so that the voice queue and the video queue are accessed in a round-robin fashion or stored in one queue. Yet in other embodiments, some voice packets maybe given priority over the voice packets. One way of implementing such a system is to provide a plurality of voice queues for voice packets with different levels of priority.

Voice digital signal processor (“DSP”) 304 is coupled to voice queue 320. and a plurality of plain-old-telephone-service (“POTS”) interfaces 308 such as Lucent dual SLIC and QSLAC. Each POTS interface 308 supports a plurality of POTS lines, e.g., up to sixteen lines. In one embodiment, each POTS interface can be Foreign Exchange Subscriber (“FXS”), or Foreign Exchange Office (“FXO”). The number of FXS/FXO depends on the configuration, but preferably there are four FXS ports on the board. POTS interface 308 includes QSLAC or an analog to digital converter (not shown) which performs the analog to digital and digital to analog conversion needed to interface the analog and FXO circuits to the digital world of the IAD.

Video DSP 305 is coupled to video queue 322 and one or more video interface 310, such as an IEEE 1394 connector or RCA connector. Voice and video DSPs 304 and 305 receive the packets and convert them into data formats that are familiar to end-user machines such as telephone, fax machines, computers, televisions, and the like. Such a packet conversion step includes depacketization to remove headers from the packets and decompression of data. In one embodiment, a single DSP may handle both voice and video packets.

Microprocessor 306 is coupled to data queue 324, an Ethernet interface 342 and a memory 344. One of the task of microprocessor 306 is to prioritize data packets so that important packets will be transmitted to a destination node without unnecessary delays.

Ethernet interface 342 connects the microprocessor to the local area network that connects together various work station computers in the system. The Ethernet interface also performs framing functions such as preamble generation and stripping, destination address checking, CRC generation and checking, automatically padding short frames on transits, and the like.

Memory 344 serves as a temporary storage space for the microprocessor and cooperates with the microprocessor to properly arbitrate the data packets according to the priority levels or packet classes. The memory includes an input storage 346 to temporarily store data packets to be forwarded to end users and an output storage 348 to temporarily store data packets to be forwarded to destination nodes in system 100 via the gateway device. The input storage and output storage have a plurality of queues 350 and a plurality of queues 352, respectively, to store separately data packets of different classes. Alternatively, the queues may be provided to store data packets according to the priority levels of the packets.

In operation, when handling inward-bound data, microprocessor 306 receives a packet from the logic device. Generally, logic device 303 transmits the data packets to the microprocessor in the order the former had received the packets, i.e., without regard as to the class type or priority level of the packets. The microprocessor identifies the class type of the packet and stores the packet in an appropriate queue 350. For example, if the packet is identified to be a C1 packet, it is stored in the queue assigned to C1 packets. Subsequently, the packets stored in the queues are transmitted to Ethernet 342 according to the priority order of the packets, in the manner similar to the data handling procedure used by traffic shaper 212. Alternatively, other methods of arbitration may be used.

Similarly, when handling outward-bound data, microprocessor 306 receives a packet from Ethernet 342. The microprocessor identifies the class type of the packet received and stores the packet in an appropriate queue 352 in the memory. The packets stored in the queues are selected and transmitted to programmable logic 303 according to the priority order of the packets using an appropriate arbitration method including those explained in connection with the traffic shaper. When logic device 303 receives the data packets from microprocessor 306, the logic device merely has to transmit the data packets in first-in-first-out method. thereby enabling the logic device and the microprocessor share the calculation intensive tasks.

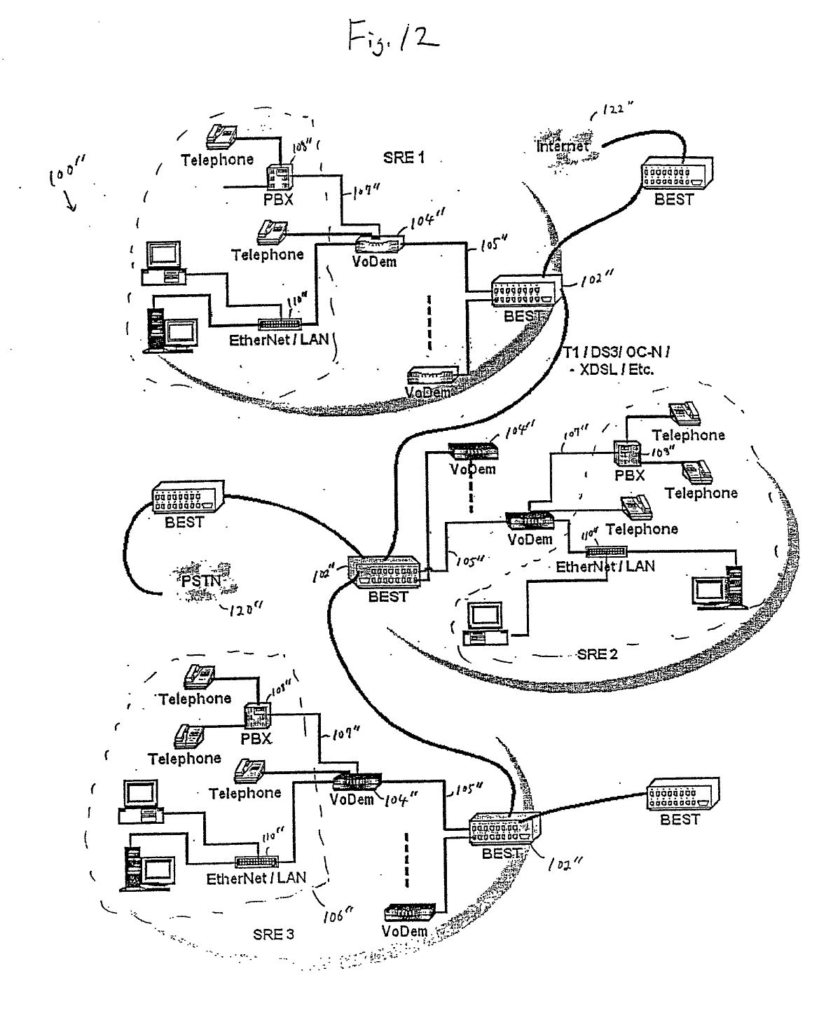

FIG. 11 illustrates a schematic diagram of a network architecture 100′ for multi-client units according to another embodiment of the present invention. Network architecture 100′ includes a plurality of smart shared real estate gateway devices or gateway device 102′. Each gateway device 102′ is provided at a multi-client unit (“MCU”) 101′ or a close proximity thereto to serve as a primary gate keeper to the outside world.

Within the MCU, a plurality of improved integrated access devices or IADs 104′ are coupled to the SRE gateway device via local loops or lines 105′. Each IAD 104′ is provided for each client within the MCU. In one embodiment, each of lines 105 is a pair of twisted copper wires and xDSL technology (e.g., VDSL) is used to transmit data to and from the gateway device to IAD 104′. Alternatively, lines 105′ may be fiber optics, coax cable, and the like. The IAD serves as a secondary gate keeper to the outside world and cooperates with gateway device 102′ to transmit or receive data.

The IAD is coupled to a client premise equipment (“CPE”) 106′ such as telephone stations, facsimile machines, multimedia equipment, personal computers, and the like via lines 107′. The CPE such as telephone stations or facsimile machines may be coupled directly to IAD 104′ or may be coupled indirectly to IAD 104′ via a private branch exchange system(“PBX”) 108′. Likewise, the CPE such as personal computers, facsimile machines, and the like may be coupled directly to IAD 104′ or indirectly to IAD 104′ via a local area network (“LAN”) 110′.

On the other side the network architecture, unlike the previous embodiment, SRE gateway device 102′ is coupled a voice network 120′ or a data network 122′ via a communication interface 116a and a communication interface 116b. The communication interfaces can be T1/E1/IMA, xDSL, DS3, OC-N, point-to-point, point-to-multipoint, wireless, and the like. The SRE gateway device is configured to operate with any one of these communication interfaces, as explained later herein. Under network architecture 100′, the gateway device determines whether the information to be transmitted is a voice or data packet and routes the packet accordingly to either voice network 120′ or data network 122′.

FIG. 12 illustrates a schematic diagram of a network architecture 100″ for multi-client units according to yet another embodiment of the present invention. Network architecture 100″ includes a plurality of smart shared real estate gateway devices or SRE gateway devices 102″. The gateway devices are interconnected in a bus topology to form a campus/regional/private area network. Alternatively, they may be interconnected in a ring, tree, mesh, or some other topology.

The plurality of the gateway devices are provided at strategic locations throughout a particular complex such as a business park, college campus, and the like. Each gateway device is coupled to a plurality of improved integrated access devices or IADs 104″ provided in one or more buildings via local loops or lines 105″. In one embodiment, each of lines 105″ is a pair of twisted copper wires and xDSL technology (e.g., VDSL) is used to transmit data to and from the gateway device to IAD 104″. Alternatively, lines 105″ may be fiber optics, coax cable, and the like. The IAD serves as a secondary gate keeper to the outside world and cooperates with SRE gateway device 102 to transmit or receive data, as explained in more details later.

The IAD is coupled to a client premise equipment (“CPE”) 106″ such as telephone stations, facsimile machines, multimedia equipment, personal computers, and the like via lines 107″. The CPE such as telephone stations or facsimile machines may be coupled directly to IAD 104″ or may be coupled indirectly to IAD 104″ via a private branch exchange system(“PBX”) 108″. Likewise, the CPE such as personal computers, facsimile machines, and the like may coupled directly to IAD 104″ or indirectly to IAD 104′ via a local area network (“LAN”) 110″.

On the other side the network architecture, one of the plurality of gateway devices 102″ is coupled to a voice network 120″ and another is coupled to a data network 122″ via a communication interface 116a″ and a communication interface 116b″. The communication interfaces can be T1/E1/IMA, xDSL, DS3, OC-N, point-to-point, point-to-multipoint, wireless, and the like. Alternatively, a single gateway device may be coupled to both voice network 120″ and data network 122″. The gateway device is configured to operate with any one of these communication interfaces.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A network system, comprising:
a plurality of integrated access devices (IADs) assigned to a plurality of clients in a multi-client unit (MCU), at least one IAD being assigned to each of the plurality of clients in the multi-client unit to transmit and receive units of information, the IADs being configured to prioritize data transmission according to the type of information included in the units of information;
an MCU gateway device assigned to the multi-client unit and coupled to the plurality of IADs to receive or transmit the units of information, the gateway device being configured to prioritize the units of information according to the type of information included in the units of information; and
a regional switching device assigned to a geographic region including the MCU, the regional switching device being coupled to the gateway device to transmit or receive the units of information to and from the gateway device, wherein the unit of information is any block of data suitable for transmission from a first node to a second node in the network system.

2. The network system of claim 1, wherein the IADs are coupled to customer premise equipment.

3. The network system of claim 1, wherein at least one IADs is coupled to an Ethernet or local area network system and a plurality of telephones.

4. The network system of claim 3, wherein at least one client includes a plurality of users.

5. The network system of claim 4, wherein at least one IAD is provided within the client's premise.

6. The network system of claim 1, wherein the units of information include cells, packets, segments, or a combination thereof.

7. The network system of claim 1, wherein the regional switching device is a wide area network link terminator or an add-drop multiplexer.

8. The network system of claim 1, wherein the gateway device is provided within the MCU.

9. The network system of claim 8, wherein the MCU is one selected from the group consisting of: a building including a plurality of tenants, a business complex, an apartment complex, an educational institution, and a plurality of buildings provided within a close proximity from each other.

10. The network system of claim 1, wherein the gateway device includes:
at least one wide area network (WAN) card to interface with the regional switching device;
at least one line card to interface with the plurality of IADs; and
at least one switch card to receive and transmit the units of information to and from the line card and the WAN card.

11. The network system of claim 10, wherein a new transmission technology can be implemented by upgrading the WAN card without making a corresponding upgrade on the IADs.

12. The network system of claim 10, wherein the gateway device includes a plurality of WAN cards, a plurality of switch cards, and a plurality of line cards.

13. The network system of claim 12, wherein the plurality of WAN cards includes:
a first WAN card dedicated to units of information transmitted under a first technology; and
a second WAN card dedicated to units of information transmitted under a second technology.

14. The network system of claim 12, wherein the plurality of WAN cards, the plurality of switch cards, and the plurality of line cards provide redundancy, so that data transmission can continue without interruption even when one or more of the WAN cards, switch cards, or line cards experience device failure or are placed out of service.

15. The network system of claim 1, wherein the units of information include voice units including voice information, video units including video information, and data units including non-voice and non-video information.

16. The network system of claim 15, wherein the voice units includes two or more of the following: voice packets transmitted under a voice-over-TCP/IP protocol, voice cells transmitted under a voice-over-ATM protocol, and voice packets transmitted under a voice-over-TDM protocol.

17. The network system of claim 15, wherein, for each client, the voice units, video units, and data units are provided with maximum and minimum data transmission rates respectively, wherein the IAD corresponding the the client guarantees the respective minimum data rates for the voice, video, and data units, and regulates the voice, video, and data units from exceeding the respective maximum data rates.

18. The network system of claim 17, wherein the gateway device guarantees the respective minimum data rates for the voice, video, and data units, and regulates the voice, video, and data units from exceeding the respective maximum data rates.

19. The network system of claim 15, wherein the data units includes a plurality of data classes to classify the data units according to the type of data contained therein.

20. The network system of claim 19, wherein the data units are prioritized for data transmission according to the data classes to which the data units are classified.

21. The network system of claim 20, wherein the plurality of data classes are classified into four different levels of priority: very high priority, high priority, medium priority, and low priority.

22. The network system of claim 1, wherein the MCU includes one or more clients that are not assigned the IADs.

23. A network system, comprising:
at least first and second integrated access devices (IADs) assigned to a plurality of clients, respectively, in a multi-client unit (MCU) to transmit and receive units of information, the IADs being configured to regulate data transmission according to the type of information included in the units of information and first maximum and first minimum data rates assigned to the respective clients, the units of information including voice units containing voice information, video units containing video information, and data units containing non-voice and non-video information;
an MCU gateway device assigned to the multi-client unit and coupled to the lADs to receive or transmit the units of information, the gateway device being configured to regulate data transmission according to the type of information included in the units of information and second maximum and second minimum data rates assigned to the respective clients; and
a regional switching device assigned to a geographic region including the MCU, the regional switching device being coupled to the gateway device to transmit or receive the units of information to and from the gateway device, wherein the unit of information is any block of data suitable for transmission from a first node to a second node in the network system.

24. The network system of claim 23, wherein the clients are provided with first and second average data rates, the first and second average data rates being used to regulate data transmission in the IADs and gateway device, respectively.

25. The network system of claim 23, wherein the first maximum and first minimum data rates and the second maximum and second minimum data rates are the same.

26. The network system of claim 25, wherein the first and second maximum and minimum data rates define maximum and minimum data transmission rates assigned to the clients for all units of information including voice, video and data units.

27. The network system of claim 25, wherein the first maximum and minimum data rates define maximum and minimum data transmission rates assigned to the clients for the voice units, video units, or data units.

28. The network system of claim 23, wherein the first maximum and first minimum data rates and the second maximum and second minimum data rates are different.

29. The network system of claim 23, wherein the units of information includes voice units containing voice information, video units containing video information, and data units containing non-voice and non-video information, wherein the voice units and video units are given priority over the data units during data transmission in the IAD and gateway device.

30. The network system of claim 29, wherein the data units separated into different different levels of priority according to the types of information included in the data units, the data units with a higher priority level being given priority over the data units with a lower priority level during data transmission in the IAD or gateway device.

31. The network system of claim 23, wherein the units of information separated into a plurality of classes according to the type of information included in the units of information, wherein the plurality of classes correspond to a plurality of priority levels.

32. A network system, comprising:
a building having a plurality of tenants;
a switching device provided at a location remote from the building;
a plurality of integrated access devices (IADs) assigned to a plurality of tenants in the building to transmit and receive units of information, the IADs being configured to regulate data transmission according to the type of information included in the units of information and first maximum and first minimum data rates assigned to the respective clients, the units of information including voice units containing voice information, video units containing video information, and data units containing nonvoice and non-video information; and
a gateway device dedicated to the building and coupled to the plurality of IADs to receive or transmit the units of information, the gateway device being configured to regulate data transmission according to the type of information included in the units of information and second maximum and second minimum data rates assigned to the respective clients, wherein the gateway device is configured to have a particular amount of bandwidth in communicating information with the switching device, the amount of bandwidth being shared by the plurality of IADs to communicate information with the switching device, wherein the unit of information is any block of data suitable for transmission from a first node to a second node in the network system.

33. The network system of claim 32, wherein the second maximum data rate is the maximum bandwidth allocated to a particular client, and the second minimum data rate is the minimum bandwidth allocated to the particular client.

34. The network system of claim 33, wherein different clients have different second maximum and minimum data rates.

35. A building area network system, comprising:.
a gateway device provided within a multi-tenant unit or within a close proximity thereto, each of the tenants in the multi-tenant units having a plurality of users, the gateway device dividing the available bandwidth among the tenants within the multiclient unit;
a tenant policy management device coupled to the gateway device, the tenant policy management device being adapted to regulate inward-bound data and outward-bound data of each of the tenants; and
a plurality of access devices each assigned to one of the tenants, each of the access devices coupled to the gateway device and coupled to one or more customer premise equipment, each of the access devices being adapted to regulate a portion of the inward-bound data and outward-bound data for the tenant to which the integrated access device is assigned.

36. The network system of claim 35, wherein the gateway device includes a traffic shaper to prioritize packets for data transmission purposes.

37. The network system of claim 35, wherein the inward and outward data between the gateway device and each access devices are in a VDSL format.

38. The network system of claim 35, wherein each of the access devices provides an IP routing service.

39. The network system of claim 35, wherein each of the access devices provides an IP security service.

40. The network system of claim 35, wherein each of the access devices provides an IP management service.

41. The network system of claim 35, wherein the customer premises equipment is selected from analog phones, PBX, computers, workstations, fax machines, routers, switches, and servers.

42. The network system of claim 35, wherein the tenants includes at least 10 tenants.

43. The network system of claim 36, wherein the gateway device comprises a form factor of an area of less than two by two by two feet in length, width, and height.

44. The network system of claim 37, wherein each of the access devices comprises a user policy manager, the user policy manager being adapted to oversee an inflow and outflow of data between each of the users and the gateway device.

45. A method for transporting and distribution of information in a building area network, the method comprising:
providing a source of information, the source of information including communication information for more than one tenant, the communication information for each of the tenants being at a selected data rate, each of the tenants including a plurality of users;
determining if the selected data rate for the tenant is within a set of predetermined limits defined for the tenant;
if the selected data rate for the tenant is within the predetermined limits, initiating a policy management process;
determining a priority decision for the communication information for the tenant using the policy management process;
enforcing the priority decision for the communication information; and
processing the communication information based upon the enforcement step to one of the tenants.

46. The method of claim 45 wherein the communication information comprises voice and data information.

47. The method of claim 45 wherein the communication information during the transferring is in a VDSL format.

48. The method of claim 45 wherein the predetermined limits are selected from a minimum data rate, a sustained data rate, a peak data rate, and a burst limit of the data rate.

49. The method of claim 45 wherein the processing is selected from operations including a discard, a transfer, or marked for transferring later if needed.

50. The method of claim 45 wherein the processing comprises temporarily storing the communication information into a memory before the communication information is transferred based upon the priority decision.

51. The method of claim 50 wherein the priority decision is based upon a priority tag and a policy.

52. The method of claim 45 wherein the steps are provided in a gateway device.

53. The method of claim 45 the communication information after the process is transferred to an access device.

54. A system for transporting and distribution of information in a building area network, the system coupled to a source of information, the source of information including communication information for more than one tenant, the communication information for each of the tenants being at a selected data rate, each of the tenants including a plurality of users, the system also including one or more memories, the one or more memories comprising:
a code directed to determining if the selected data rate for the tenant is within a set of predetermined limits defined for the tenant;
a code directed to initiating a policy management process if the selected data rate for the tenant is within the predetermined limits;
a code directed to determining a priority decision for the communication information for the tenant using the policy management process;
a code directed to enforcing the priority decision for the communication information; and
a code directed to processing the communication information based upon the enforcement step to one of the tenants.
